(19) United States
(12) Patent Application Publication
(10) Pub. No.: US 2024/0290304 A1
(43) Pub. Date: Aug. 29, 2024

(54) WIND CHIME WITH REMOTE AUDIO SOUND

(71) Applicant: Nigrelli Inc., Kiel, WI (US)

(72) Inventor: Biagio Nigrelli, JR., Valders, WI (US)

(73) Assignee: Nigrelli Inc., Kiel, WI (US)

(21) Appl. No.: 18/174,970

(22) Filed: Feb. 27, 2023

(51) Int. Cl. G10H 1/00; F21V 33/00; G10K 1/067; G10K 1/10; H05B 47/115

(52) U.S. Cl. CPC G10H 1/0008; F21V 33/00; G10H 1/0083; G10K 1/067; G10K 1/10; H05B 47/115; F21Y 2115/10; G10H 2220/021; G10H 2220/461

(57) ABSTRACT

A wind chime including a series of individual chime tubes suspended below a base, and a striker suspended below the base and movable into contact with the plurality of chime tubes. The wind chime further includes an accelerometer positioned within each of the chime tubes and operable to generate an accelerometer signal upon contact between the striker and the chime tube. A chime control unit is included which is in communication with each of the accelerometers to receive the accelerometer signals and wirelessly transmit the accelerometer signals away from the location of the wind chime. A receiving station is located remotely from the chime control unit and is operable to receive the accelerometer signals and convert the accelerometer signals to a tone signal. The wind chime includes a playback device operable to audibly transmit the tone signals.

### FIELD

The present disclosure generally relates to a wind chime. More specifically, the present disclosure relates a wind chime that transmits output signals to a remote location such that the output signals can be played as audible and/or visual representations of the contact between a striker and chime tubes of the wind chime.

### BACKGROUND

The present disclosure relates to a wind chime that generates sound and/or visual images at a location remote from the wind chime. Decorative wind chimes are used in landscaping arrangements for producing chiming sounds based upon the influence of wind. However, current wind chimes are configured such that the chiming sounds are produced at any time of day, and only in an area surrounding the wind chime. The present inventors created an improved wind chime which can be silenced during period of time when chiming sounds are not desirable, such as during sleeping hours or during times when noise is undesirable. Additionally, the improved wind chime includes means for producing audio output at customizable locations using external sound systems.

### SUMMARY

The present disclosure describes a wind chime comprising a plurality of individual chime tubes suspended below a base, and a striker suspended below the base. The wind chime tubes are positioned and configured such that the striker is movable into contact with the wind chime tubes under influence of the wind. The wind chime tubes are formed of a non-resonating material such that the wind chime tubes do not produce sound when coming into contact with the striker. The wind chime further includes an accelerometer positioned within each of the chime tubes and operable to generate an accelerometer signal upon contact between the striker and the chime tube. A chime control unit is included which is in communication with each of the accelerometers to receive the accelerometer signals and convert the accelerometer signals to a tone signal. The chime control unit is configured to wirelessly transmit the accelerometer signals or the tone signals, or both, to a receiving station. The receiving station is located remotely from the chime control unit and is operable to receive the accelerometer signals and convert the accelerometer signals to a tone signal based upon user selected operational settings. In other embodiments, the receiving station receives tone signals from the chime control unit. The wind chime includes a playback device operable to audibly transmit the tone signals.

In certain embodiments, the chime control unit is configured to receive an output signal from the accelerometer and transmit the output signal to the receiving station. The receiving station is configured to receive and translate the output signal into a command signal. The receiving station is further configured to transmit the command signal to an output device, which is configured to receive the command signal and create an output based upon the command signal. The output could be an audible output, a visual output, or both.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a perspective view of a wind chime of the present disclosure;

FIG. 2 is a side view of the wind chime;

FIG. 3 is a schematic view of the electronic operating components of the wind chime operating according to an embodiment having an audible display;

FIG. 4 is a schematic view of the electronic operating components of the wind chime operating according to an embodiment having a visual display; and

FIG. 5 is a flowchart illustrating the operating steps of method for controlling the operation of the wind chime according to an exemplary embodiment.

### DETAILED DESCRIPTION

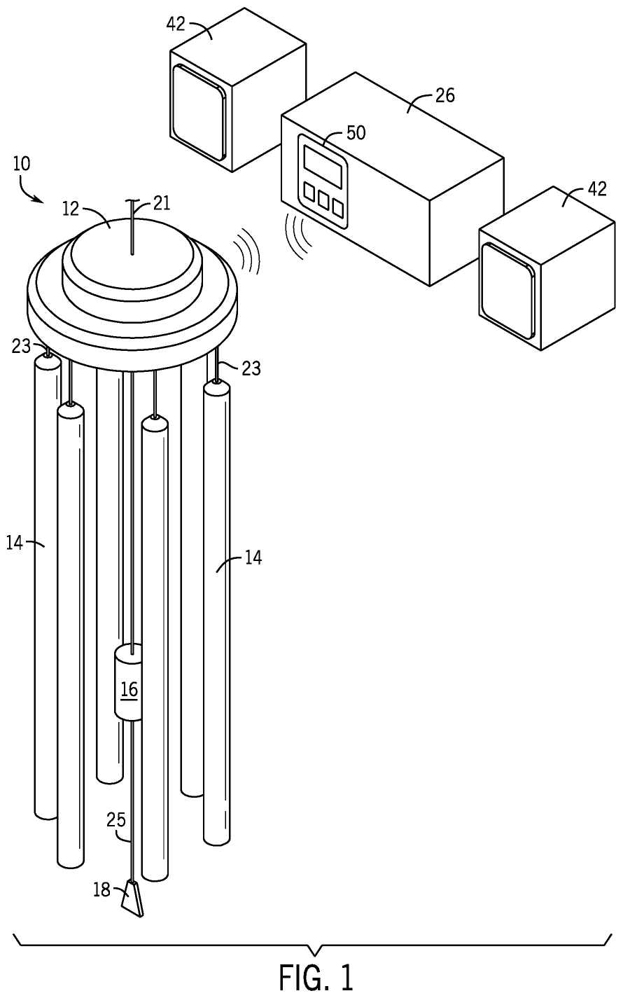

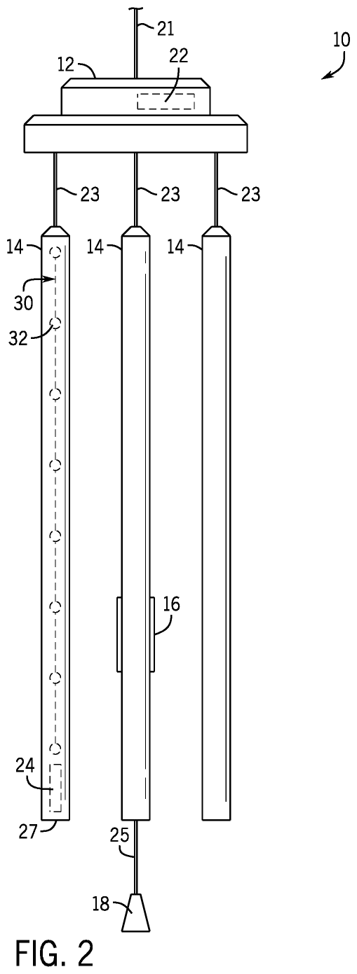

FIGS. 1-2 illustrate a wind chime 10 constructed in accordance with the present disclosure. The wind chime 10 includes a base 12, a plurality of wind chime tubes 14, and a striker 16. The base 12 includes upper and lower cylindrical sections and is suspended via a cable 21 that is connected to the base 12 at a center-point of the base 12. The cable 21 generally defines a center, support axis for the entire wind chime 10. In the embodiment illustrated, the wind chime tubes 14 are elongated cylinders, which are positioned circumferentially about the longitudinal axis. The wind chime tubes 14 are each suspended via cables 23 from the base 12 and extend downward and generally parallel to the center support axis. The striker 16 is a solid cylinder, which is suspended via a center cable 25 from the center-point of the base 12. The striker 16 is suspended along the center support axis such that the striker 16 is generally centered between the plurality of wind chime tubes 14. A flag 18 is suspended a distance beneath the striker 16 via the cable 25. The flag 18 is positioned below each of the wind chime tubes 14 and is designed to be movable due to the influence of wind.

The wind chime tubes 14 are formed from a non-resonating material such that the non-resonating material minimizes the sound of impact between the striker 16 and the wind chime tubes 14. As an example, the wind chime tubes 14 could be formed from a molded nylon or plastic, although other materials are contemplated as being within the scope of the present disclosure.

As shown in FIG. 2, the wind chime 10 is constructed to include an accelerometer 24 in each of the wind chime tubes 14. FIG. 2 illustrates the location of the accelerometer 24 in one of the wind chime tubes 14, with the understanding that each of the plurality of wind chime tubes 14 would include a separate accelerometer 24. Each accelerometer 24 is positioned at a first end 27 of the respective wind chime tube 24. It is contemplated that each accelerometer 24 would be located near the lowermost end of the wind chime tube 24 such that the accelerometer 24 would detect the maximum amount of vibration due to the striker 16 contacting the wind chime tube 4 due to the influence of the wind. However, the accelerometer 24 could be located in different locations along the length of the wind chime tube 24. Each accelerometer 24 generates acceleration signals which correspond to an impact force between the respective wind chime tube 14 and the striker 16.

In some embodiments of the present disclosure, the wind chime 10 further includes an LED strip 30 positioned within or on each of the wind chime tubes 14. The LED strip 30 includes a plurality of light-emitting diodes 32, which are connected in series and extend through the wind chime tube 14. In an embodiment in which the LED strip 30 is located within the cylindrical open interior of the wind chime tube 14, the wind chime tube 14 would be formed from a transparent or translucent material such that the light generated by the LED strip 30 would be visible through the wind chime tube 14.

In the embodiment shown in FIG. 2, the LED strip 30 and the accelerometer 24 included within the respective wind chime tube 14 would be electrically connected to a chime control unit 22 located within the base 12. The electrical connections extend through or along the support cable 23 that supports the wind chime tube 14 beneath the base. In this manner, the chime control unit 22 is able to both communicate and provide power to the LED strip 30 and accelerometer 24. This configuration, however, is not limiting. In alternate embodiments the LED strip 30 and the accelerometer 24 can be in communication with the control unit 22 wirelessly, and as such would each include a power supply within the respective wind chime tube 14.

The present inventors recognized a need and desire for a wind chime unit which utilizes the interactions between the striker and the wind chime tubes to produce audible output at a remote location and/or visual output at the wind chime 10 for decorative, landscaping arrangements while reducing or eliminating the audible output at the wind chime 10. The present disclosure provides a wind chime apparatus which outputs accelerometer readings generated by interactions between the wind chime tubes and the striker to a control system, which converts the accelerometer readings to audible and/or visual commands based upon user-selected parameters.

Referring to FIGS. 1-2, the wind chime 10 includes a user interface 50, a chime control unit 22 located within the base 12, and a receiving station 26. The user interface 50 is positioned remotely from the wind chime 10 and can be any one of a touch enabled display screen, a remote, a series of switches or buttons, and/or the like. The user interface 50 is configured to communicate wirelessly with the chime control unit 22. The chime control unit 22 is positioned within the base 12 and includes a power supply 60, such as a battery, solar cells or other type of energy storage or generating system. The receiving station 26 is positioned remotely from the wind chime 10 and as such, the chime control unit 22 and the receiving station 26 are configured to communicate wirelessly. The receiving station 26 includes at least one of a visual or audible output device, such as the speakers 42 illustrated.

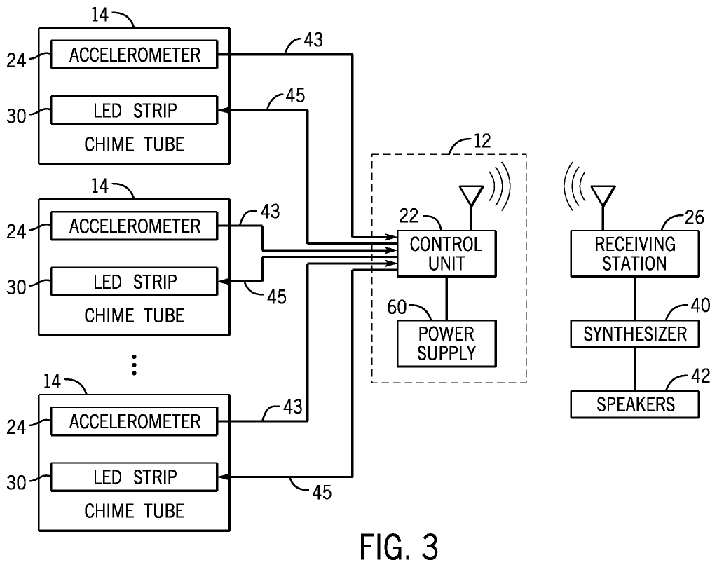

Referring to FIG. 3, the receiving station 26 includes a wireless transceiver that allows for bi-direction communication to and from the receiving station 26. The receiving station 26 in the embodiment shown includes or is connected to a synthesizer 40 and a speaker 42. The chime control unit 22 is configured to receive the acceleration signals generated by each of the accelerometers 24 through the communication lines 43. The chime control unit 22 converts the acceleration signals into output values which are then wirelessly transmitted to the receiver 26 utilizing a wireless transceiver that is include either as part of the chime control unit 22 or as a separate component in communication with the chime control unit 22. In the depicted embodiment, the chime control unit 22 is additionally configured to transmit commands to the LED strips 30 along the LED control wires 45 based upon the acceleration signal. As an illustrative example, the chime control unit 22 can control the color of the LEDs 32, the sequence of operation of the LEDs 32 or the pattern of illumination or any combination thereof based on the acceleration signal received from the accelerometer 24 associated with the wind chime tube 14 including the LED strip 30. Although the communication line 43 and the LED control wires 45 are shown as wired connections, the wired connections between the chime control unit 22 and the LED strip 30 and the accelerometer 24 could be replaced by a wireless connection.

Upon receipt of the acceleration signals, the receiver 26 is then configured to transmit the output values to the synthesizer 40, which generates audio output which is then transmitted via the speaker 42. The output values sent to the synthesizer 40 can include different sounds for each wind chime tube 14, different sounds for the magnitude of the acceleration signals, different sounds based on the sequence of acceleration signals from the plurality of wind chime tubes 14 or any combination thereof. In certain embodiments, the receiver 26 is configured to receive and translate the output values from the chime control unit 22 into commands which are then transmitted to the synthesizer 40.

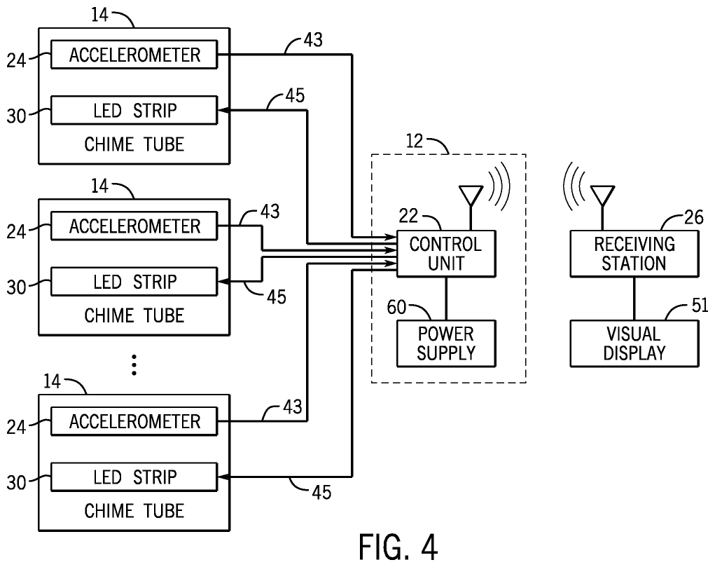

Referring to FIG. 4, in a second contemplated embodiment of the present disclosure, the receiving station 26 includes a visual display 51. As described above, the chime control unit 22 is configured to receive the acceleration signals generated by the accelerometers 24. The chime control unit 22 converts the acceleration signals into output values which are wirelessly transmitted from the chime control unit 22 to the receiver 26. In the depicted embodiment, the chime control unit 22 is again configured to transmit commands to the LED strips 30 based upon the acceleration signals. The receiver 26 is then configured to transmit the output values to the visual display 51, which generates visual output that is in addition to the activation of the LED strips 30. In certain embodiments, the receiver 26 is configured to receive and translate the output values from the chime control unit 22 into commands which are then transmitted to the visual display 51.

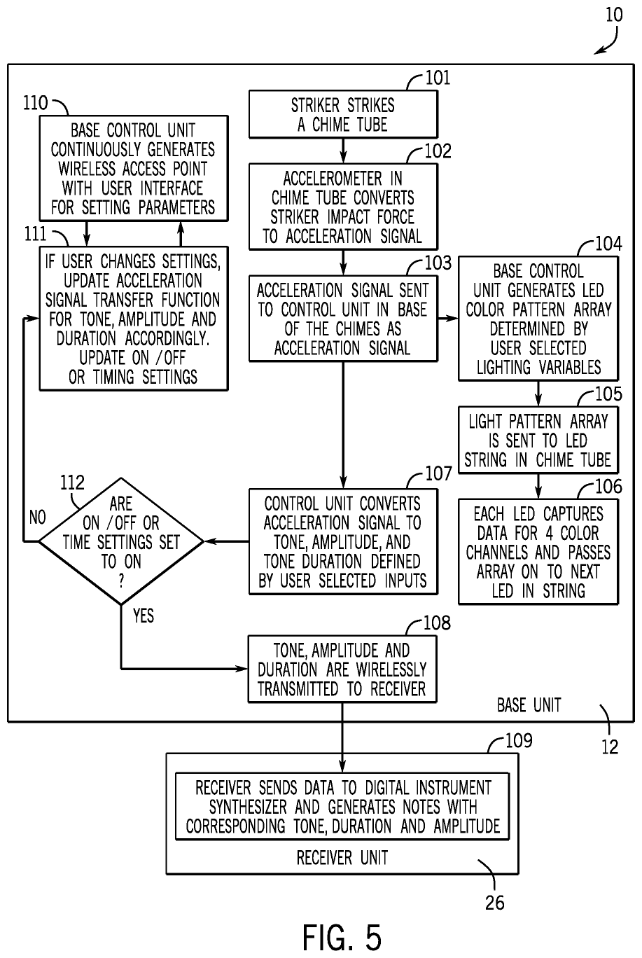

FIG. 5 provides a flowchart that provides one representation of the wind chime operating according to a contemplated method of one an exemplary embodiment. In such an embodiment, the user interface 50 shown in FIG. 1 allows a user to select power settings, operating setting and output parameters, which generate control commands to the chime control unit 22 utilizing the wireless transceivers of both the chime control unit 22 and the receiver 26. The chime control unit 22 can then output commands to the LED strips 30 and the receiving station 26 according to operating parameters entered by the user at the user interface 50.

As an illustrative example, the user can adjust the power settings to allow the user to select ON, OFF, or TIMED, which automatically sets the power setting to OFF after a set duration of time. This setting allows the user to determine when the wind chime 10 will be operating and generating sound and/or audible outputs. In this manner, the user can turn off the wind chime 10 at night or in the early mornings, unlike a conventional wind chime that generates sound whenever wind is present. The output parameters selected by the user determine how the acceleration signal is converted to a tone signal, which can be customized according to tone, amplitude, and tone duration. The output parameters selected by the user also determine how the acceleration signal is converted to an LED color pattern array, which can be customized according to brightness, color, and lighting duration.

In use, the striker 14 is actuated by wind currents such that the striker 16 strikes the wind chime tubes 14 at step 101. When the striker 16 contacts the wind chime tubes 14, the accelerometer associated with the wind chime tube 14 converts the impact force of the striker 16 on the wind chime tube 14 into an acceleration signal at step 102. The accelerometer 24 outputs the acceleration signal to the control unit 22 along the communication line 43 shown in FIGS. 3 and 4 at step 103. As shown in step 110, the chime control unit 22 continuously generates wireless access points with the user interface 50 to determine the settings input by the user. If at any point the user changes the power setting, updates the acceleration signal transfer function for the tone generated or any of the other output parameters, the chime control unit 22 is adjusted accordingly as shown in step 111.

Upon receiving the acceleration signal, at step 104, the chime control unit 22 generates the LED color pattern array determined by the user-selected output parameters. As described previously, the user can select various parameters of the LED color pattern, such as the color of the LEDs, the frequency of operation of the LEDs, the order the LEDs are activated, the pattern created by the LED activation or a variety of other parameter. The LED color pattern array is output to the LED strips 32 at step 105. Each individual light-emitting diode 34 of each LED strip 32 receives and is activated according to the LED color pattern array at step 106.

Additionally, upon receiving the acceleration signal, at step 107 the chime control unit 22 converts the acceleration signal to a tone signal according to the user-selected output parameters. The output parameters selected by the user can include a wide variety of sound variable, such as but not limited to volume, pitch, tone, duration of sound, type of instrument or any other parameter that is desirable to the user. Further, each of the individual wind chime tubes 14 could have its own sound, pitch duration or any other parameter. Such selection would replicate wind chime tubes having different lengths or sizes to create different sounds upon being struck by the striker 16.

If the method determines in step 112 that the wind chime is on, the chime control unit 22 wirelessly transmits the tone signal to the receiving station 26 at step 108. At step 109, the receiving station 26 outputs the tone signal to a digital instrument synthesizer 40, which is configured to generate notes having the user selected tone, duration and amplitude via a playback device. As described in FIGS. 3 and 4, the playback device could be an audible device or a visual device, or both.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A wind chime, comprising:
a plurality of individual chime tubes each suspended below a base;
a striker suspended below the base and movable into contact with the plurality of chime tubes;
an accelerometer positioned within each of the chime tube and operable to generate an accelerometer signal based upon contact between the striker and the chime tube;
a chime control unit in communication with each of the accelerometers to receive the accelerometer signals and convert the accelerometer signals into a tone signal, wherein the chime control unit wirelessly transmits the tone signals;
a receiving station located remotely from the chime control unit and operable to receive the tone signals from the chime control unit; and
a playback device operable to audibly transmit the tone signals.

2. The wind chime of claim 1 wherein each of the plurality of chime tubes is formed from a non-resonating material.

3. The wind chime of claim 2 wherein non-resonating material minimizes the sound of impact between the striker and the chime tubes.

4. The wind chime of claim 1 further comprising one or more light emitting diodes (LEDs) included in each of the plurality of chime tube.

5. The wind chime of claim 4 wherein the chime control unit is operable to activate the LEDs in each of the chime tubes based upon the accelerometer signals from the accelerometer associated with the chime tube.

6. The wind chime of claim 1 wherein the value of the accelerometer signal is based upon a striking force between the striker and the chime tube.

7. The wind chime of claim 6 wherein the tone signal is based on the value of the accelerometer signal.

8. The wind chime of claim 1 wherein the accelerometer signal include an identity of the chime tube.

9. The wind chime of claim 8 wherein the tone signal is based on the identity of the chime tube.

10. A wind chime, comprising:
a plurality of individual chime tubes each suspended below a base;
a striker suspended below the base and movable into contact with the plurality of chime tubes based upon an influence of wind;
an accelerometer positioned within each of the chime tube and operable to generate an accelerometer signal upon contact between the striker and the chime tube;
a chime control unit in communication with each of the accelerometers to receive the accelerometer signals and convert the accelerometer signals into a output signal, wherein the chime control unit wirelessly transmit the output signals;
a receiving station located remotely from the chime control unit and operable to receive the output signals; and
an output device operable to create an output based on the output signal received from the receiving station.

11. The wind chime of claim 10 wherein the output is a visual output.

12. The wind chime of claim 10 wherein the output is an audible output.

13. The wind chime of claim 10 wherein each of the plurality of chime tubes is formed from a non-resonating material.

14. The wind chime of claim 13 wherein non-resonating material minimizes the sound of impact between the striker and the chime tubes.

15. The wind chime of claim 10 further comprising one or more light emitting diodes (LEDs) included in each of the plurality of chime tube.

16. The wind chime of claim 15 wherein the chime control unit is operable to activate the LEDs in each of the chime tubes based upon the accelerometer signals from the accelerometer associated with the chime tube.

17. The wind chime of claim 10 wherein the receiving station is configured to receive and translate the output signal from the chime control center into a command signal.

18. The wind chime of claim 17 wherein the receiving station is configured to transmit the command signal to the output device.
